(19) United States
(12) Patent Application Publication
(10) Pub. No.: US 2009/0078172 A1
(43) Pub. Date: Mar. 26, 2009

(54) System and method for parking vehicles

(76) Inventors: Jean-Claude Kaufmann, New York, NY (US); Christopher Dale Langhart, New Hope, PA (US); John Chester, High Bridge, NJ (US)

Correspondence Address: KENYON & KENYON LLP, ONE BROADWAY, NEW YORK, NY, 10004, US

(21) Appl. No.: 11/903,479

(22) Filed: Sep. 21, 2007

(51) Int. Cl. B65D 19/38; B60G 7/02; E04H 6/12; G06F 7/00

(52) U.S. Cl. 108/57.17; 280/86.751; 414/253; 700/219

(57) ABSTRACT

Set forth are systems and methods for moving objects in a structure, and particularly to parking vehicles within a parking structure. A system may include a pallet configured to receive an object, e.g., a vehicle; a structure including a plurality of modules configured to receive the pallet with the object, wherein the modules include multi-directional pallet transfer systems, the pallet transfer systems configured to transfer the pallet with the object to adjacent modules in any one of four orthogonal directions.

### FIELD OF THE INVENTION

The present invention relates to a system and method for moving and storing objects, and more particularly, to parking vehicles in a parking structure.

### BACKGROUND

Providing adequate parking for vehicles, particularly in urban and other heavily populated areas, has been problematic for many years and is expected to be progressively more so in the future. As the populations of such urban areas continues to grow, the space available for the parking of vehicles become increasingly restricted and expensive.

Currently, vehicles are typically parked in parking structures that provide elevators and ramps for moving the vehicles within the structures. Another known, though less common, system is the type that employs pallets on which the vehicles are positioned, the system employing various mechanical equipment in order to move vehicles within the parking structure while the vehicles remain on the pallets. In such arrangements, it is typical that a vehicle is positioned on a pallet and the system is configured to mechanically move the pallet in either one direction, e.g., forward of the vehicle's front end, or two directions, e.g., forward of the vehicle's front end or backwards of the vehicle's rear end. In this type of arrangement, the entire elevator traverses the length or width of the garage along a gantry aisle. Providing adequate space for this traversal reduces space that would otherwise be available for parking. Moreover, according to these arrangements, there can only be parking bays two deep on either end of the pallet, thus limiting the size of the parking facility—additional parking would require the addition of a second elevator system, which would require a second gantry aisle, which would in turn consume more space and reduce the amount of this space available for parking. Various systems are also known that combine moving and stationary elevators and carousel-like schemes for locating and storing the vehicles on pallets.

These pallet-type parking systems, while an improvement over conventional, e.g., ramp-type, parking systems, still do not maximize the space available for parking vehicles.

Thus, it may be desirable to employ a system and method that provides an improved manner for parking vehicles.

### SUMMARY

The present invention relates to a system and method for moving objects in a structure, and particularly to parking vehicles within a parking structure. In accordance with an embodiment, the present invention may provide a system, comprising: a pallet configured to receive an object; a structure including a plurality of modules configured to receive the pallet with the object, wherein the modules include multi-directional pallet transfer systems, the pallet transfer systems configured to transfer the pallet with the object to adjacent modules in any one of a first forward direction, a second rear direction, a third side direction and a fourth side direction. The object may be a vehicle. The structure is a parking structure, e.g., a multi-level parking structure. The system may further comprise a lift configured to travel between levels of the parking structure. The transfer lift may also include a multi-directional pallet transfer system, the pallet transfer system configured to transfer the pallet with the vehicle from the lift to adjacent different parking modules in any one of the first forward direction, the second rear direction, the third side direction and the fourth side direction.

The modules and the lift may each be modular to provide an extremely flexible system that may be adapted based on factors such as, e.g., parking demand, target vehicle retrieval times, space limitations, and aesthetics.

In an embodiment, the parking structure includes posts or column segments that support parking modules including truss support arrangements that are configured to receive the pallet with the vehicle. The pallet transfer system may include air casters, sensors and roller systems. The roller system may include a roller, an actuator, sensors and roller driver. The roller driver may be driven by a motor or by link to one or more motors. The pallet transfer system may be arranged within the truss or beam support arrangements.

Advantageously, the structure may have a modular construction. Also, the system may further comprise several separate turntable module or ones that is combined within the modular structure unit that is configured to rotate a pallet having the object thereon. The turntables may include air casters, sensors, and rollers also. Still further, the system may further comprise sensors and a control system configured to control the actuation of the pallet transfer system. The control system may include software and a user interface. The user interface may be configured to provide data corresponding to a desired retrieval of a stored object.

In accordance with another embodiment, the present invention may provide a system comprising: a pallet configured to receive an object; a plurality of individual modules configured to receive the pallet with the object, the modules including multi-directional pallet transfer systems, the pallet transfer systems configured to transfer the pallet with the object to adjacent modules in any one of four orthogonal directions, wherein the plurality of individual modules have posts that couple to posts of other individual modules so as to form a modular structure, enabling the modular structure to be made up of individual modules in any plan arrangement and at various heights or numbers of levels.

In an embodiment, the object is a vehicle. The structure may be a parking structure, e.g., a multi-level parking structure. The lift may be configured to travel between levels of the parking structure. The transfer lift may also include a multi-directional pallet transfer system, the pallet transfer system configured to transfer the pallet with the vehicle from the lift to adjacent different parking modules in any one of the first forward direction, the second rear direction, the third side direction and the fourth side direction. The individual modules may include, connected between the respective posts, a truss or beam support arrangement that is configured to receive the pallet with the vehicle.

The pallet transfer system may include air casters, sensors, and roller systems. The roller system may include a roller, sensors an actuator and roller driver. The roller driver may be driven by a motor or by a link to one or more motors. The pallet transfer system may be arranged within the truss or beam support arrangements. The system may further comprise a separate turntable module or one that is combined within the modular structure unit that is configured to rotate a pallet having the object thereon. The turntable module may include an arrangement of air casters sensors and rollers.

The system may further comprise a control system configured to sense and control the actuation of the pallet transfer system. The control system may include software and a user interface. The user interface may be configured to provide data corresponding to a desired retrieval of a stored object.

In accordance with another embodiment, the present invention may provide a system comprising: a pallet configured to receive an object; a structure including a plurality of modules configured to receive the pallet with the object, the modules including multi-directional pallet transfer systems, the pallet transfer systems configured to transfer the pallet with the object to adjacent modules in a plurality of directions; and a sensor and a control system configured to automatically engage and disengage the multi-directional pallet transfer systems of each module as a pallet is moved relative to the modules. The object on the pallet may be a vehicle. The structure may be a parking structure, e.g., a multi-level parking structure. The system may further comprise a lift configured to travel between levels of the parking structure. The lift may also comprise a multi-directional pallet transfer system, the pallet transfer system configured to transfer the pallet with the vehicle from the lift to adjacent parking modules in any one of a first forward direction, a second rear direction, a third side direction and a fourth side direction. In this regard, the lift may be accessible from all four sides. The accessibility of the lift from multiple sides at any of its several levels (e.g., 2, 3, or 4 sides) allows the lift to effectively function as pass-through spaces, thereby increasing the efficiency of the system.

The parking structure may include posts that support the parking modules including truss or beam support arrangements that are configured to receive the pallet with the vehicle. The pallet transfer system may include air casters, sensors, and roller systems. The roller system may include a roller, sensors, an actuator, and roller driver. The roller driver may be driven by a motor or a link to one or more motors. The pallet transfer system may be arranged within the truss or beam support arrangements. The structure may have a modular construction. Also, the system may further comprise separate turntable modules or one that is combined within the modular structure unit that is configured to rotate a pallet having the object thereon. The turntable may include air casters sensors and rollers. The system may also include fire protection systems, lighting systems and security systems including television cameras.

In an embodiment, the control system may be configured to receive from a user a request to retrieve from the structure any given module. Upon receiving from a user a request to retrieve from the structure a given module, the control system may be configured to prioritize the retrieval based upon at least one of a first-come-first-served basis, an amount of fees that is collected from each user, an environmental ranking of the vehicles, a shortest average retrieval time period and energy expenditure, etc. The control system may include software that determines the shortest amount of time to retrieve a vehicle. The software may be configured to use as a factor in determining the shortest amount of time to retrieve a vehicle at least one of the following parameters: the size of the parking structure, the number of vehicles that are currently parked in the parking structure, the number of vehicles that are expected to be parked in the parking structure, the time of day, the type of vehicles, etc. Also, the control system may communicate via a user interface to receive a request for retrieving a vehicle.

In accordance with another embodiment, the present invention may provide a method for moving an object in a structure, comprising: positioning the object on a pallet;

transferring the pallet and the object from a lift to a first module that is orthogonally located relative to the lift via multi-directional pallet transfer system of the first module and the lift; transferring the pallet and the object from the first module to a second module that is orthogonally located relative to the first module via the multi-directional pallet transfer system of the first module and a multi-directional pallet transfer system of the second module.

In this embodiment, the object may be a vehicle. The structure may be a parking structure. The structure may be a multi-level parking structure. In the method, the system may also include a lift with multiple elevator cabs configured to travel between levels of the parking structure. The lift may also include a multi-directional pallet transfer system at each cab level, the pallet transfer system configured to transfer the pallet with the vehicle from the lift to adjacent different parking modules in any one of the first forward direction, the second rear direction, the third side direction and the fourth side direction. The parking structure may include posts that support parking modules including truss or beam support arrangements that are configured to receive the pallet with the vehicle. The pallet transfer system may include air casters, sensors, and roller systems. The roller system may include a roller, sensors, an actuator and roller driver. Also, the method may include the step of controlling the actuation of the pallet transfer system via a control system and measuring the results with sensors.

In accordance with another embodiment, the present invention may provide a method for parking a vehicle in a structure and subsequently retrieving the vehicle, comprising: positioning the vehicle on a pallet; transferring the pallet and the vehicle from a lift to a parking module and between different parking modules, wherein the lift and parking modules include multi-directional pallet transfer systems, the pallet transfer systems configured to transfer the pallet with the vehicle to different parking modules in any one of a first forward direction, a second rear direction, a third side direction and a fourth side direction; positioning the pallet and vehicle in a designated parking module; awaiting a command to retrieve the pallet and vehicle; positioning the lift to retrieve the pallet and vehicle; transferring the pallet and vehicle to the lift; and positioning the lift for retrieval of the vehicle and rotation of the vehicle via a turntable.

In an embodiment the command is generated by a user, e.g., by a telephone, computer, swiping a card in an automated card reader, etc. The user may generate the command by sending a request to retrieve the vehicle. Additionally or alternatively, the command may be generated by software that is configured to determine when a user is likely to a request to retrieve the vehicle. In this embodiment, upon the software determining when a user is likely to request to retrieve the vehicle, the controller may move at least one pallet so as to enable the vehicle to be retrieved in a predetermined fashion, e.g., so as to achieve a shorter retrieval time for the vehicle, etc. A monitoring system may be included for the tracking of vehicle position either on site or remotely.

In an example according to an embodiment of the present invention, a unit for storage has a first module including a multi-directional pallet transfer system, where the pallet transfer system may transfer a pallet with an object to adjacent modules in any one of a first forward direction, a second rear direction, a third side direction and a fourth side direction. The module may be configured to be adjoined to the adjacent modules, securely stacked on top of a lower module, and/or have an upper module securely stacked thereon. The object may be an automobile. Furthermore, the first module may have a truss or beam structure. The pallet transfer system may have air casters and a roller system, where the roller system may include a roller, an actuator and roller driver. Moreover, the multidirectional pallet transfer system may be controlled by a computer program.

Additional features of the system and method of the present invention are discussed in greater detail below.

### BRIEF DESCRIPTION OF THE DRAWINGS

FIG. 1(a) is a schematic diagram that illustrates a top view of a basic parking module, according to an embodiment of the present invention;

FIG. 1(b) is a schematic diagram that illustrates a side view of the basic parking module shown in FIG. 1(a);

FIG. 1(c) is a schematic diagram that illustrates an end view of the basic parking module shown in FIG. 1(a);

FIG. 2 is a partial side view of the posts of a basic parking module, according to an embodiment of the present invention;

FIG. 3 is a diagram that illustrates a top view of a coupling arrangement for respective posts of four basic parking modules, according to an embodiment of the present invention; and

FIG. 4(a) is a diagram that illustrates a side view of a roller drive unit, according to an embodiment of the present invention;

FIG. 4(b) is a diagram that illustrates a front view of the roller drive unit shown in FIG. 4(a);

FIG. 5 is a schematic diagram that illustrates a top view of two basic parking modules that form a turntable, according to an embodiment of the present invention;

FIG. 6 is a schematic diagram that illustrates a perspective view of a basic parking module having a pallet and vehicle thereon, according to an embodiment of the present invention;

FIGS. 7(a) and 7(b) illustrate a conventional parking structure (having ramps, etc.) and a parking structure that employs the system of the present invention, respectively; and

FIG. 8 illustrates a layout of various floors according to a particular embodiment of the system.

FIG. 9 shows a section view of a multi-level elevator.

### DETAILED DESCRIPTION

The present invention, according to one embodiment thereof, is directed to a system and method for parking vehicles in a parking structure. However, it should be recognized that the system and methods set forth herein may be employed for moving and storing any conceivable item, not merely vehicles. For example, the system and methods set forth herein may be employed for moving sorting and storing boxes, crates, etc., that may be loaded onto pallets. It is also possible that the system and methods set forth herein may be employed for moving and storing boxes, crates, etc., without them being loaded onto pallets. Thus, while the example embodiments set forth herein relate to the parking of vehicles in a parking structure, these example embodiments are for illustration purposes only and are not meant to limit the scope of this application only to the parking of vehicles in a parking structure.

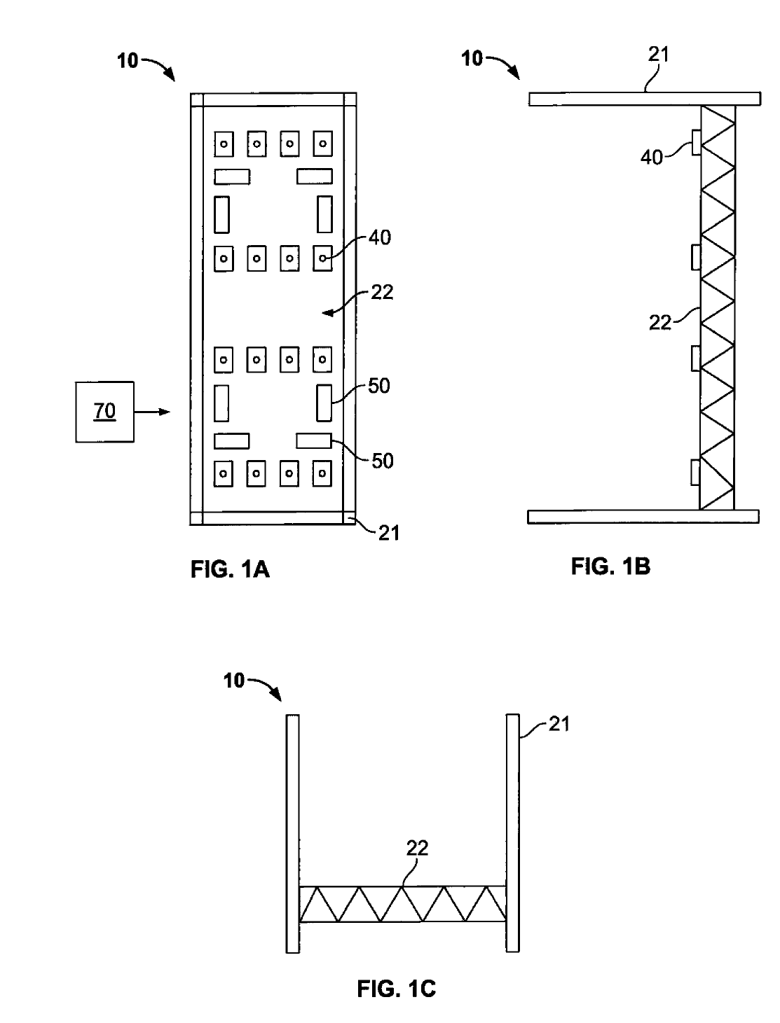

FIG. 1(a) is a schematic diagram that illustrates a top view of a basic parking module that may be employed in the present invention, according to an embodiment of the present invention. In addition, FIGS. 1(b) and 1(c) are schematic diagrams that illustrate side and end views, respectively, of the basic parking module shown in FIG. 1(a). Advantageously, a plurality of basic parking modules 10 are assembled together so as to form a parking structure 100 (discussed in further detail below). This modular type structure enables the structure to take any conceivable form, e.g., the footprint of an irregularly shaped building or lot which may otherwise be unsuitable for use as a parking structure.

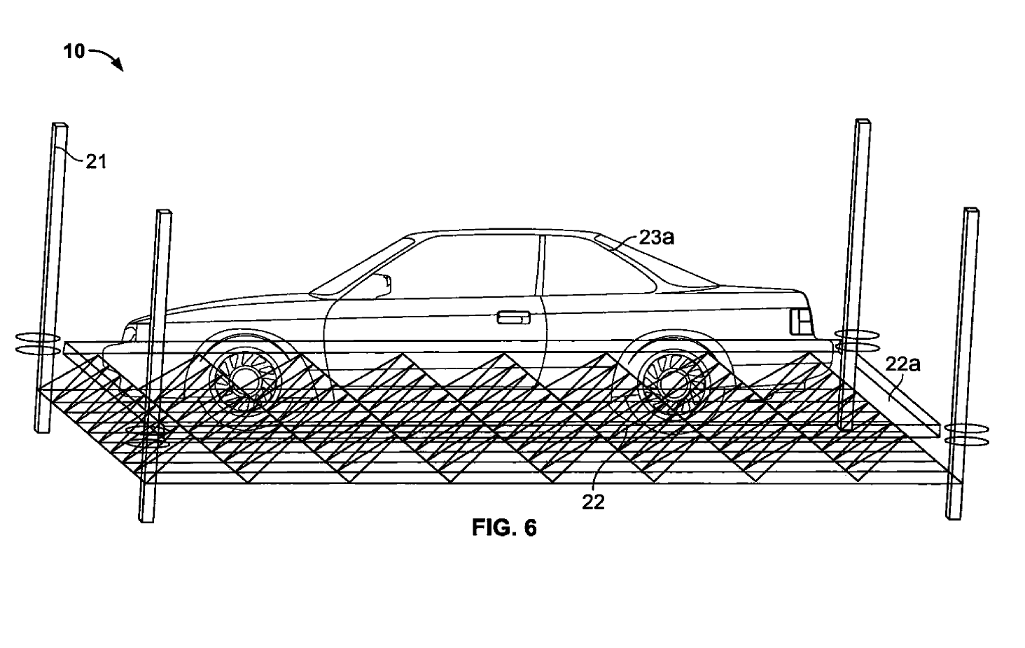

Referring to FIG. 1(a), the basic parking module 10 includes a generally horizontal planar surface 22 that may be formed by a truss or beam system, e.g., an octet truss (additional details of an example of such a truss system are illustrated in FIG. 6, which also illustrates a pallet 22a and a vehicle 23a being positioned thereon). Positioned on or within the planar surface 22, e.g., within the spaces that are defined by the structural components that form the truss system, are various sensors and aircasters 40 and roller drive units 50. The various aircasters 40 provide a lift component to a pallet that is placed thereupon, while the roller drive units 50 provide a mechanism for moving the lifted pallets in any lateral direction, e.g., forward, backwards, and to either side.

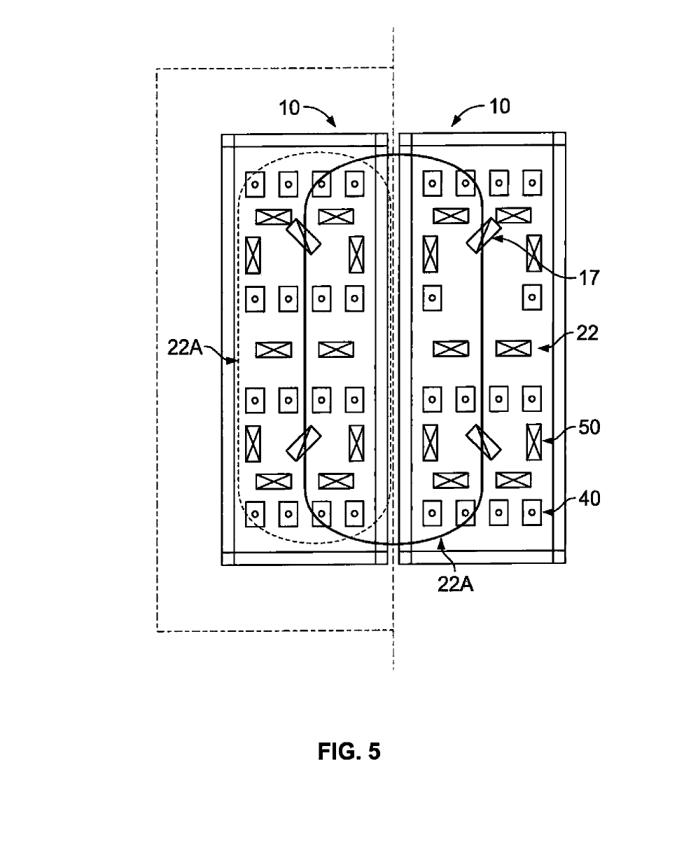

In the embodiment shown, the basic parking module 10 may include sixteen aircasters 40, arranged as shown in FIG. 1(a), although any number of aircasters 40 may be employed in any conceivable arrangement. The number and arrangement of the aircasters 40 shown in FIG. 1(a) have the advantage of providing adequate support, at various locations, to a pallet that is placed thereupon, and to continue to provide adequate support when the pallet is moved, in any direction, relative to the basic parking module 10. In addition, in the embodiment shown, the basic parking module 10 may include eight roller drive units 50, arranged as shown in FIG. 1(a), although any number of roller drive units 50 may be employed in any conceivable arrangement. The number and arrangement of the roller drive units 50 shown in FIG. 1(a) have the advantage of being able to move a pallet that is placed thereupon in any direction relative to the basic parking module 10. Referring to FIG. 5, it is noted that the basic parking module 10 that is illustrated in FIG. 1(a) may be combined to form a “turntable.” It may be noted that pallet 22A may move one half pallet width to the left or right as shown in FIG. 5 to be positioned midway between two unit 10 support decks. This provides sufficient space for the pallet 22A to be rotated 180 degrees by additional rollers 17 (that are set at various angles relative to the orthogonally-arranged aircasters 40 and roller drive units 50). This rotates or turns a vehicle once it has reached a particular location. Once rotated, the pallet may be shifted one half space back over a single module 10 for further movement to other modules. For example, such a turntable may advantageously be placed in a location at which a vehicle is retrieved, thereby enabling a vehicle to be turned towards an exit that a driver may pass through. Such an arrangement may reduce the amount of space that is needed for a parking structure, since a driver would be facing an exit upon the vehicle being turned, thereby eliminating the need for the driver to turn the car around before exiting.

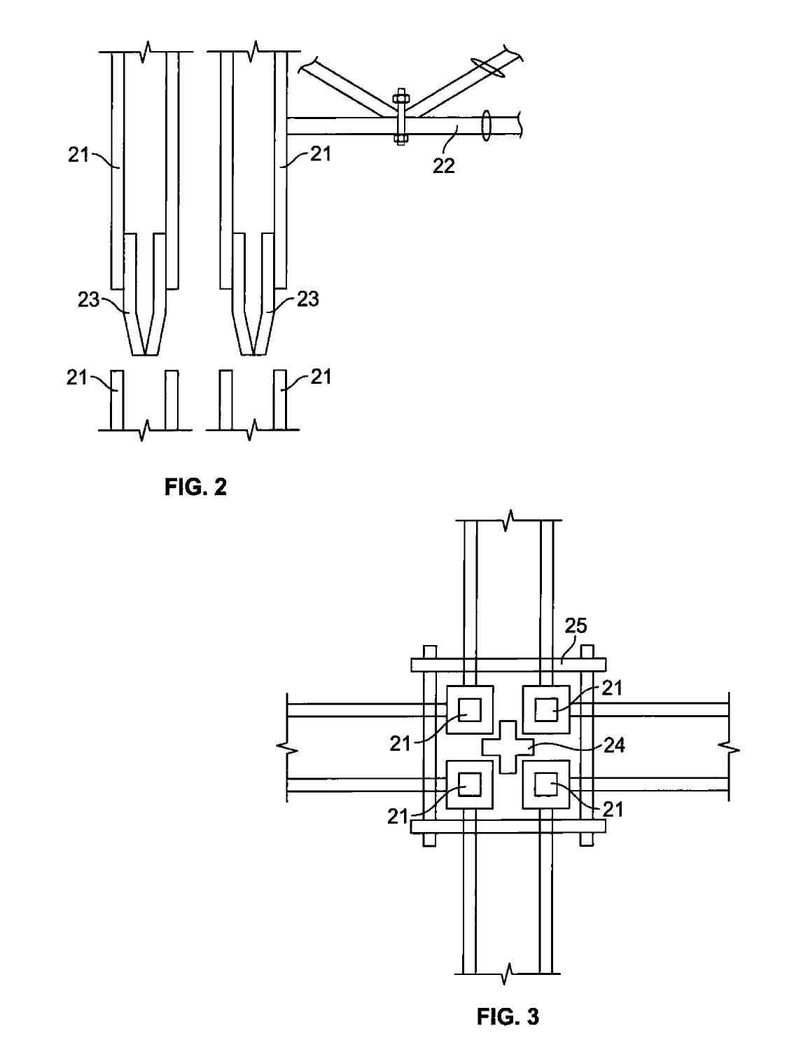

Referring again to FIG. 1(a), the basic parking module 10 also includes a post/column segment 21 located in each one of its four corners. As shown in FIG. 1(b), the posts 21 extend vertically both above and below the planar surface 22. Referring now to FIG. 2, there is shown some additional details of the posts 21. Advantageously, the posts 21 are configured so as to be stackable, e.g., the lower portion of each one of the four posts 21 of a first basic parking module 10 is configured to mate with, and/or be locked together with, a corresponding upper portion of each one of four posts 21 of a second basic parking module 10. In this manner, the second basic parking module 10 may be stacked on top of the first basic parking module. In the embodiment shown in FIG. 2, the posts 21 comprise a hollow tube, each having an aligning probe 23 at its lower portion that fits within the hollow tube of the posts directly below it. This configuration allows easy location and assembly of the first and second basic parking modules 10 relative to each other when the second basic parking module 10 is lowered into place, e.g., via an overhead crane, onto the first basic parking module 10. A pin or bolt-type anchoring arrangement, which may operate to keep the aligning probe 23 of the upper post 21 from pulling out of the hollow tube of the lower post 21, may prevent the second basic parking module 10 from being unintentionally raised relative to or being unintentionally disassembled from the first basic parking module 10, e.g., due to wind or any other type of uplift force.

Referring now to FIG. 3, there are shown some additional details of the posts 21. Advantageously, the posts 21 are configured so as to also be positionable laterally, e.g., side-by-side and parallel, relative to other posts. More specifically, any one or more of the four posts 21 of a first basic parking module 10 may be connected to, and/or be locked together with, a corresponding one or more of the four posts 21 of other basic parking modules 10. FIG. 3 illustrates an arrangement in which four basic parking modules 10 are positioned laterally relative to each other, with posts 21 of each one the four basic parking modules 10 being attached to each other by a parallel post connection device 24. In this manner, a first basic parking module 10 may be combined with any one or more of other basic parking modules 10 in order to provide an arrangement of adjacent basic parking modules 10. These adjacent basic parking modules 10 may form a level or floor of a parking structure, and additional levels or floors of the parking structure may be added thereon by the stacking of additional basic parking modules onto the first level or floor (as shown in FIG. 2).

In the embodiment shown in FIG. 3, the parallel post connection device may include a spacer bracket 24 that has a cross-section that resembles a “+” sign. The spacer bracket 24 is configured to fit between the four posts 21 in order to maintain the four posts 21 in a parallel position relative to each other. In addition, the parallel post connection device may include frames 25 that also maintain the four posts 21 in a parallel position relative to each other. Of course, while the spacer bracket 24 that is shown in FIG. 3 is particularly suited for a location in which four posts 21, each one being from a respective one of four basic parking modules 10, are arranged adjacently relative to each other, other configurations of the spacer bracket 24 may be employed when less than four posts are arranged together. For example, at the outer edge of a parking structure, there may be locations at which respective posts 21 of only two basic parking modules 10 are adjacent to each other, and the spacer bracket 24 that is employed to connect these two posts 21 and to maintain them in parallel relative to each other may be any suitable shape. Other shapes of the spacer bracket 24 may be employed when three basic parking modules 10 are positioned adjacent to each other.

The space between the frames 25 that are not occupied by the respective posts 21 and the spacer bracket 24 may be employed for various functions. For example, this unoccupied space may be employed to house, e.g., cables, hoses, piping, etc., that is used by the various components of the basic parking module 10. This use of the space is particularly advantageous as it enables such cables, hoses, piping, etc., to be protected from being damaged by pallets as such pallets are moved over and between various ones of the basic parking modules 10.

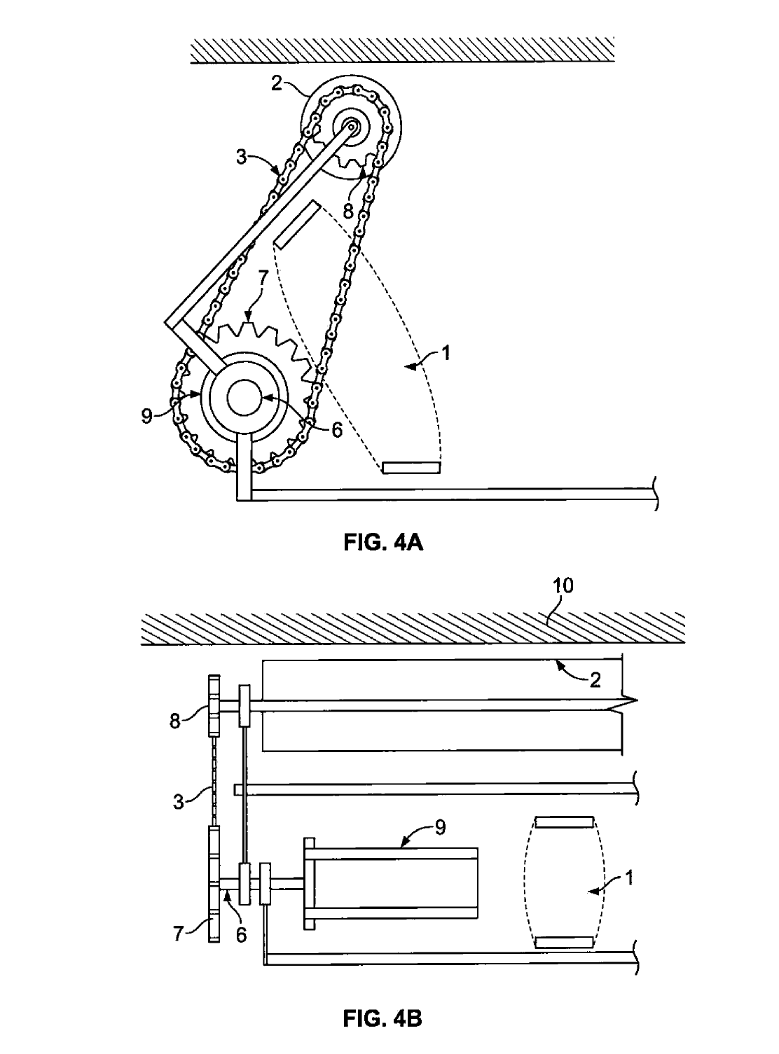

FIGS. 4(a) and 4(b) illustrate additional features of the roller drive units 50, according to an example embodiment of the present invention. As set forth above, the roller drive units 50 provide a mechanism for moving, in any lateral direction, e.g., forward, backwards, and to either side, a pallet that is located on the basic parking module 10 and that has been lifted by the aircasters 40. In this manner, a pallet (e.g., having a vehicle disposed thereon) may be moved by the roller drive units 50 of a first basic parking module 10 until the pallet is then positioned on a second, adjacent basic parking module 10, and the roller drive units 50 of the second basic parking module 10 may then be operated to move the pallet again until the pallet is then positioned on a third, adjacent basic parking module 10, and so on. In this manner, the pallet is successively moved by one or more of the basic parking modules 10 until the pallet is desirably positioned on a target basic parking module 10, e.g., a basic parking module 10 on which the pallet may be temporarily maintained.

Referring now to FIG. 4(a), there is described a roller drive unit 50 according to an example embodiment of the present invention. Generally, motion of a pallet is provided by the rollers 2 which may be selectively raised and lowered. As the pallet is slightly raised by the air casters 40, one or more rollers 2 of one or more respective roller drive units 50 may be employed to direct its motion; acceleration, deceleration, stopping and direction. This may be accomplished by the one or more rollers 2 of one or more respective roller drive units 50 being raised in order to contact an underside of the pallet. Upon contacting the underside of the pallet, the rollers 2 rollingly engage the underside of the pallet, e.g., by friction or by rack-like bumps on the underside of the pallet, in order to permit the several rollers 2 to push the pallet to the desired position. As the motion progresses, additional air casters 40 and rollers 2 may be engaged when the pallet covers them, thereby permitting still further motion of the pallet. As the pallet moves past a particular roller drive unit 50 and/or a particular aircaster 40, the aircaster 40 and/or the roller drive unit 50 may be lowered. Advantageously, this raising and lowering of particular roller drive units 50 and/or a particular aircasters 40 takes place automatically, e.g., via a control system, which is set forth in additional detail below.

In the embodiment shown, rotation of the roller 2 is provided by a motor 9, e.g., an air motor 9. Preferably, the air motor 9 is configured to operate the rollers 9 in a bi-directional manner, e.g., to operate the rollers 2 in a first rotational direction in order to move a pallet in a first lateral direction relative thereto, and to operate the rollers 2 in a second rotational direction, opposite the first rotational direction, in order to move a pallet in a second lateral direction, opposite the first lateral direction, relative thereto. In an embodiment, the rollers 2 may be in continuous rotation. Alternatively, the rollers 2 may be stationary in a normal state and may begin rotating upon actuation and contact with the pallet.

In addition to the rollers 2, the roller drive unit 50 may also include an actuator 1 for performing the selective raising and lowering of the rollers 2. In the embodiment shown, the actuator 1 is an inflatable, or otherwise expandable, element which, when inflated or expanded, pushes the roller 2 upwardly and into contact with the underside of the pallet. More specifically, the roller 2 may be caused to rise by it being partially rotated around a longitudinal axis of axle 6. Preferably, as the roller 2 rises, e.g., by it being partially rotated around a longitudinal axis of axle 6, a chain 3 is kept in tension during its movement. In an alternative embodiment, the chain 3 may instead be a gear belt or the like. Advantageously, it is preferred that such belt or chain 3 not lose tension while the roller 2 is raised or lowered, so as to reliably maintain the movement of the components. The belt or chain 3 transmits power to the roller 2 via a sprocket 8 from a sprocket 7 which is driven by a motor 9.

It should be recognized that the above-described mechanism for selectively raising and lowering the roller 2 may comprise any suitable components for doing so. For example, in alternative embodiments of the present invention, the system 10 may employ a pneumatic and/or hydraulic cylinder or the like to selectively raise and lower the roller 2.

The system 10 may also include a control system 70, which is illustrated schematically in FIG. 1(a). The control system 70 may be coupled to the various components of the basic parking module 10, e.g., the air casters 40 and the roller drive units 50, in order to sense and control their movements. Specifically, in a preferred embodiment, actuation of the rotation of the rollers 2 and/or of the selective raising and lowering mechanism may be controlled by the controller 70, which may be configured to time and coordinate these movements in accordance with the positions and/or direction of movements of the pallets. Also, the controller 70 may be configured to simultaneously operate one or more air casters 40 and/or roller drive units 50 that are located adjacent to each other, so as to be sure that the components work in tandem and in sequence and that a pallet that is moved thereby is acted upon by the various components evenly and may be moved straight, e.g., in the intended direction and without moving askew.

Of course, any type of control system that is capable of controlling the movement and sensing of the various components of the basic parking module 10, in order to move pallets thereupon, may be employed in the present invention. Advantageously, the control system 70 includes software that provides intelligence in determining how to control the movement of the various components of the basic parking module 10.

Still further, the control system 70 advantageously also includes software that provides intelligence in determining how to move the pallets within the parking structure in order to achieve a desired objective. For example, in an example embodiment of the present invention, the control system 70 may include software that provides intelligence in determining how to move the pallets within the parking structure in order to minimize the amount of time that is required in order to retrieve a vehicle that has been parked in the parking structure. In this embodiment, the software may consider such factors as how often a vehicle is moved, when a person anticipates returning to retrieve the vehicle, how many vehicles may be parked in the parking structure at any given time, etc. In this manner, the software may determine where to park a particular vehicle, and where to park other vehicles in the parking structure, so as to be able to retrieve and return the vehicle to an individual that is retrieving it in the shortest amount of time or within a pre-determined acceptable time period. For example, if a person that uses a vehicle every day, e.g., at a given time of the morning to go to work, leaves the vehicle at night for over-night parking, the software of the control system 70 may determine where to park the vehicle within the parking structure in order to insure that the vehicle can be retrieved and returned to the individual the following morning within, e.g., two minutes. Alternatively, if a person that uses a vehicle irregularly, e.g., once a week, leaves the vehicle for parking within the parking structure, the software of the control system 70 may determine where to park the vehicle within the parking structure in order to insure that the vehicle can be retrieved and returned to the individual when next requested within, e.g., three minutes.

It should be recognized that the amount of time that the software determines is an appropriate amount of time to retrieve a vehicle may depend on any number of different factors. For example, the software may use as a factor in determining an appropriate amount of time to retrieve a vehicle, e.g., the size of the parking structure, the number of vehicles that are currently parked in the parking structure, the number of vehicles that are expected to be parked in the parking structure, the time of day, the type of vehicles, etc. Also the software program can be updated to accommodate change of usage patterns, change of capacity or any other type of operational change, e.g adding entrances and exits or elevator elements.

Also, the software may use user preferences as a factor in determining an appropriate amount of time to retrieve a vehicle. In this embodiment, a user may provide, at some point in time, a time period that he or she feels is an acceptable amount of time to wait for a vehicle to be retrieved from the parking structure. For example, in an embodiment, a user may provide such information during a registration period, and the software may store this information in a suitable database. Upon the user indicating a desire to have the vehicle retrieved, the software may access the database and use the information to retrieve the information in accordance with the stored time preference. Alternatively, a user may provide such information immediately prior to desiring to pick up the vehicle. This may occur when the user, e.g., makes a request for the vehicle to be retrieved, such as by a telephone call to an automated system, a computer generated request, etc. Also, this may occur when the user, e.g., swipes a card on the premise, the card imparting data to an automated card reader system that communicates with the control system for retrieving the vehicle. This automated card reader may be located in any conceivable location, for example, in a retrieval bay of the parking structure, in an elevator of a building leading to such a retrieval bay. Upon the user indicating a desire to have the vehicle retrieved by swiping the card through the automated card reader, the software may access the database and use the information to retrieve the vehicle within a given amount of time. A system that includes, e.g., a card reader in an elevator (or some other location that is remote from the parking structure but that may be in a location that a user may frequent immediately before picking up the vehicle), may improve a user's satisfaction with the amount of time needed to retrieve a vehicle, since it enables an arrangement in which the vehicle can be in the process of being retrieved while the user is still traveling towards the retrieval bay.

It should be recognized that the manner in which the software determines how to prioritize the retrieval of any given vehicle may also include any number of possible factors. For example, if two or more users request the retrieval of their respective vehicles at approximately the same time, the control system 70 may prioritize the retrieval based upon factors such as, e.g., a first-come-first-served basis, an amount of fees that is collected from each user (e.g., such that a user that pays a higher fee gets preferential treatment) or an environmental ranking of the vehicles (e.g., a small compact car may get preferential treatment over a gas-guzzler vehicle so as to provide an incentive to users to buy and park vehicles that are environmentally friendly). Additionally or alternatively, the control system 70 may determine, upon receiving two or more requests to retrieve vehicles, a retrieval schedule that provides for the shortest average retrieval time period for the two vehicles. Additionally or alternatively, the control system 70 may determine, upon receiving two or more requests to retrieve vehicles, a retrieval schedule that requires the smallest expenditure of energy to retrieve the two or more vehicles.

Furthermore, the control system 70 may move vehicles, in accordance with any of the above-mentioned factors, prior to receiving a request from a user to retrieve a vehicle. For example, the control system 70 may make its own determination of when a user is likely to make a request to retrieve a vehicle (e.g., based upon the a time provided by a user, or based upon an evaluation of the user's typical retrieval pattern, etc.), and to move vehicles in advance of receiving a request from the user to retrieve a vehicle. Thus, if the control system 70 determines that a user is likely to make a request to retrieve his or her vehicle at a given time, the control system 70 may begin moving vehicles, including the user's vehicle, in order to have the user's vehicle in a suitable location within the parking structure that enables it to be retrieved in accordance with any of the above-mentioned factors. For example, if the control system 70 is configured so as to provide for the retrieval of a vehicle within a two minute time period, the control system may, upon determining that a user is likely to make a request to retrieve his or her vehicle at, e.g., 8 a.m., begin moving vehicles several minutes (or hours, or any period of time that is calculated to be optimal), including the user's vehicle, in order to have the user's vehicle in a suitable location within the parking structure that enables it to be retrieved in two minutes or less. Likewise, if the control system 70 is configured so as to provide for the retrieval of a vehicle with the least energy expenditure possible, the control system may, upon determining that a user is likely to make a request to retrieve his or her vehicle at, e.g., 8 a.m., begin moving vehicles several minutes (or hours, or any period of time that is calculated to be optimal), including the user's vehicle, in order to have the user's vehicle in a suitable location within the parking structure that enables it to be retrieved with the least energy expenditure possible. Of course, the control system 70 may be configured to begin moving vehicles several minutes (or hours, or any period of time that is calculated to be optimal) in advance of an anticipated retrieval request, in order to have the user's vehicle in a suitable location within the parking structure for meeting any of the above-mentioned factors, or any other conceivable factors.

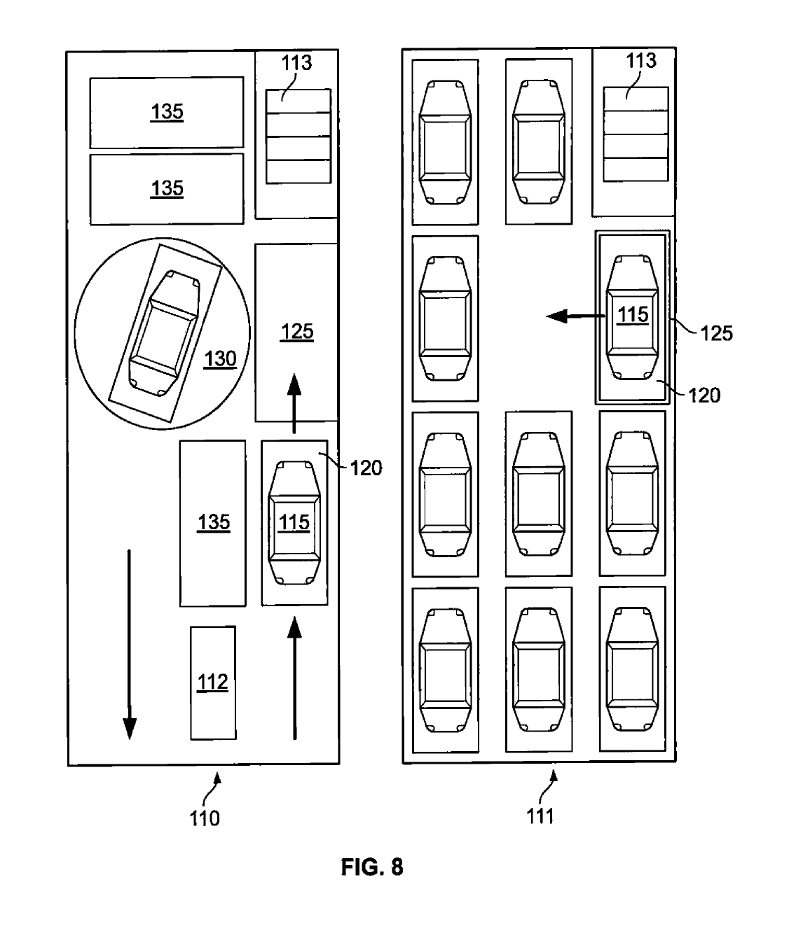

FIG. 8 illustrates a layout of various floors according to a particular embodiment of the system. In particular, a ground floor 110 and additional floors 111 (for example, floors 2 through 10) are shown. The ground floor has a cashier station 112, and there is a stairwell 113 that extends to each floor of the system. When a vehicle 115 arrives at the ground floor 110 of the parking facility, it is driven onto a pallet 120, at which point the entry module system checks that its size is not too large for acceptance. Each pallet is approximately 19′×8′ in this example. The height of the vehicle typically should not exceed 7.5′, but it will be appreciated that, according to some embodiments, other heights may be accommodated. Once size verification is confirmed, the driver exits the vehicle 115 and inputs information regarding the length of time anticipated and the method of payment into a touch pad screen and receives a coded ticket. The pallet 110 positions itself for entry into the elevator 125 with the vehicle nose first. On subsequent floors 111, the elevator 125 can be accessed from multiple sides. The elevator 125 moves the car to the floor selected by a software program based on the estimated retrieval time indicated by the driver. From the moment the software program has identified a spot for the vehicle 115, pallets on the selected floor 111 begin moving so that a path to the selected spot will be open when the elevator 125 arrives. When the owner returns to retrieve the vehicle 115, he or she places the coded ticket into a reader which determines the amount to be paid. Simultaneously, the software program locates the vehicle 115 and positions it at the elevator 125 for delivery. After payment is confirmed, the vehicle 115 enters the elevator 125 and descends/ascends to the ground floor 110. Upon reaching the ground floor 110, typically at street level, the vehicle 115 exits the elevator 125 laterally onto a turntable 130 built into the floor. The turntable 130 rotates the vehicle approximately 180° so the driver can exit onto the street in forward mode. As each pallet 120 is occupied by an incoming vehicle, the software program signals for a new pallet to be put in place for the next vehicle. As most vehicles arrive in the morning and exit in the evening (or arrive at the beginning of an event and exit at the end) the facility contains a storage system including pallet storage areas 135 for keeping pallets available on the ground floor behind the turntable. Pallets 120 will be able to freely travel over the turntable 130 and to be positioned to accept the next incoming vehicle or store the empty pallet. The physical configuration of the facility is almost limitless as the modular system and transport mechanism allow for maximum floor plan and stacking flexibility.

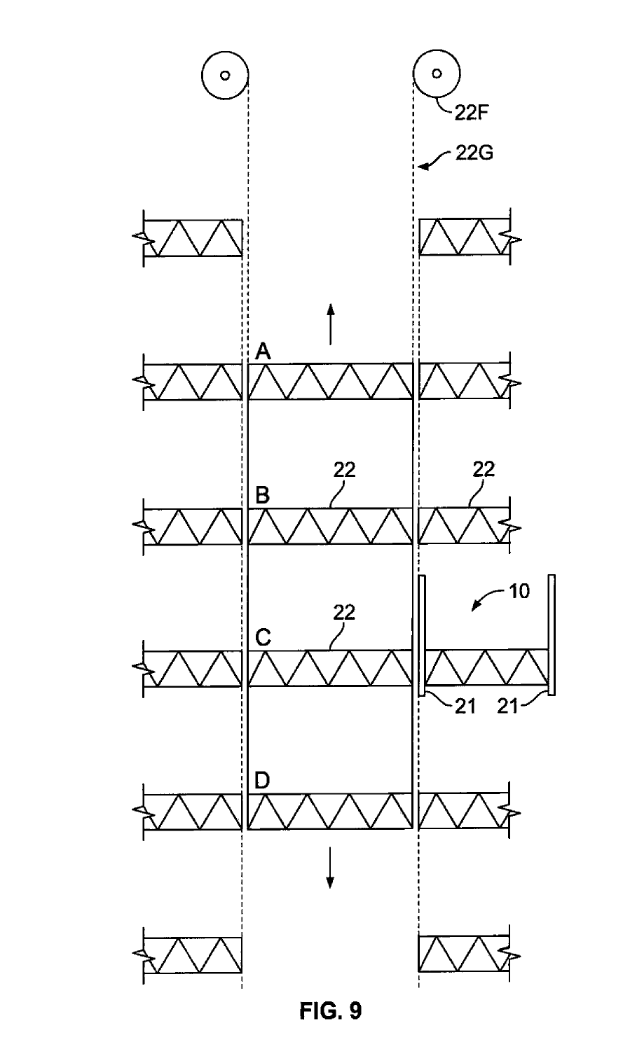

FIG. 9, shows a section view of a multi-level elevator. The elevator has elevator modules 22A, 22B, 22C, 22D with trusses and are the same as parking modules 10, except elevator modules 22A, 22B, 22C, 22D are supported by tension member 22G allowing motion as a unit up and down by power unit 22F. This permits (in this example, four) floors to move cars/pallets orthogonally through the elevator shaft for efficiency of positioning. The elevator modules may shuffle pallets between floors by, for example, by shunting a pallet onto a floor and picking it up on a different level of the elevator. The modular nature of the elevator provides added flexibility in that elevator modules can be added or removed based on need. In the example depicted in FIG. 9, if, for example, three of the four modules were removed, the remaining elevator would travel to each floor.

The various embodiments of the present invention set forth hereinabove may provide many advantages over conventional systems for moving and storing objects, and in particular for parking vehicles in a parking structure. For example, because the plurality of basic parking modules 10 may be assembled together so as to form a parking structure 100 in any conceivable arrangement, and furthermore because the individual basic parking modules are each equipped with components for moving pallets relative thereto in any direction, a modular-type parking structure may conform to a building site, e.g., even an irregularly shaped building whose footprint might otherwise be incompatible or unsuitable for use as a conventional parking structure with ramps, cranes, etc.

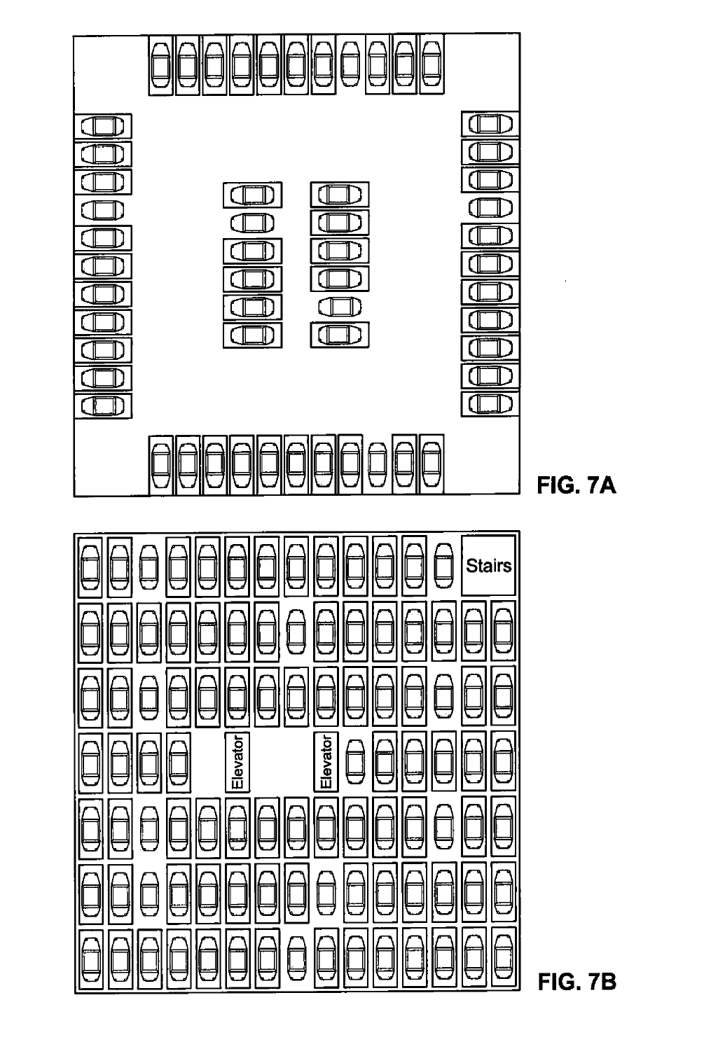

In addition, because the individual basic parking modules are each equipped with components and sensors for moving pallets relative thereto in any direction, the parking structure 100 may be capable of storing, e.g., parking, many more vehicles in a given space as compared to conventional systems for parking vehicles in a parking structure. FIGS. 7(a) and 7(b) illustrate a conventional parking structure (having ramps, etc.) and a parking structure that employs the system of the present invention, respectively. It should be evident that the parking structure that employs the system of the present invention may park a significantly greater number of vehicles in the same space as compared to the conventional parking structure (having ramps, etc.). For example, the structure illustrated in FIG. 7(b) can hold 98 spaces, while the conventional structure illustrated in FIG. 7(a) can hold only 56 spaces per level.

The elevator units are also constructed in a modular fashion each level being stacked upon the previous. Each elevator essentially being a module 10. This means that the elevator stack may be located at any vertical point in the structure and also that more than one elevator stack may be employed to facilitate the operation. In the example embodiment depicted at FIG. 7(b), the elevator has a multi-directional pallet transfer system, wherein the pallet transfer system can transfer the pallet with the vehicle from the elevator lift to adjacent parking modules in any one of a first forward direction, a second rear direction, a third side direction and a fourth side direction. This accessibility from four sides allows the lift to function as a pass-through space, thereby effectively increasing the efficiency of the system. Although the elevators depicted at FIG. 7(b) are accessible from 4 sides, it will be appreciated that, according to other example embodiments, the elevator may be accessible from less than four sides. For example, if the elevator were adjacent to a side wall, it would be accessible from 3 sides, or if the elevator were in a corner, it would be accessible from 2 sides. However, the pass-through ability may be retained as long as at least two sides are accessible.

Furthermore, having individual basic parking modules 10 that are identical or at least very similar to each other greatly simplifies the manufacturing process, the construction and assembly process, etc., thereby providing significant cost benefits. For example, a parking structure 100 may be constructed of any number of the individual basic parking modules 10 which may be assembled on-site with a crane or the like, eliminating many of the costs and complexities of typical building construction.

It is further noted that, like the parking modules, the elevators of the example embodiment are modular as well. This modularity of the elevators allows an even greater amount of flexibility in system design and adaptation. In this regard, the elevator stacks may be placed at any location within the structure, and/or the elevator stacks may be staggered. Moreover, the elevator stacks (as is also true with respect to the parking modules), may be added or removed, in response to, e.g., increased or decreased parking demands.

Still further, the above-described control system 70 may provide numerous benefits over conventional systems for moving and storing objects, and in particular for parking vehicles in a parking structure. For example, the control system 70, and in particular the software that is employed by the control system 70, may provide intelligence in optimizing the operation of the various components that make up the parking structure 100. In this manner, performance criteria (such as being able to retrieve a vehicle in a predetermined amount of time or using less than a predetermined amount of energy, etc.) may be achieved, thereby improving customer satisfaction, reducing costs of operation, etc.

Thus, the several aforementioned objects and advantages of the present invention are most effectively attained. Those skilled in the art will appreciate that numerous modifications of the exemplary embodiment described hereinabove may be made without departing from the spirit and scope of the invention. Although various exemplary embodiments of the present invention have been described and disclosed in detail herein, it should be understood that this invention is in no sense limited thereby.

What is claimed is:

1. A system, comprising:
a pallet configured to receive an object; and
a structure including a plurality of modules configured to receive the pallet with the object,
wherein the modules include multi-directional pallet transfer systems, the pallet transfer systems configured to transfer the pallet with the object to adjacent modules in any one of a first forward direction, a second rear direction, a third side direction and a fourth side direction.

2. The system of claim 1, wherein the object is a vehicle.

3. The system of claim 2, wherein the structure is a parking structure.

4. The system of claim 3, wherein the structure is a multi-level parking structure.

5. The system of claim 4, further comprising a multi-level lift configured to travel between levels of the parking structure.

6. The system of claim 5, wherein the transfer lift also includes a multi-directional pallet transfer system, the pallet transfer system configured to transfer the pallet with the vehicle from the lift to adjacent different parking modules in any one of the first forward direction, the second rear direction, the third side direction and the fourth side direction.

7. The system of claim 6, wherein the parking structure includes posts that support parking modules including truss support arrangements that are configured to receive the pallet with the vehicle.

8. The system of claim 1, wherein the pallet transfer system includes air casters and roller systems.

9. The system of claim 8, wherein the roller systems include a roller, an actuator and roller driver.

10. The system of claim 9, wherein the roller driver is a motor.

11. The system of claim 10, wherein the pallet transfer system is situated within the truss support arrangements.

12. The system of claim 1, wherein the structure had a modular construction.

13. The system of claim 1, further comprising at least one turntable module that is configured to rotate a pallet having the object thereon.

14. The system of claim 13, wherein the one or more turntable modules include air casters and rollers.

15. The system of claim 1, further comprising a control system configured to control the actuation of the pallet transfer systems.

16. The system of claim 15, wherein the control system includes software and a user interface.

17. The system of claim 16, wherein the user interface is configured to provide data corresponding to a desired retrieval of a stored object.

18. A system, comprising:
a pallet configured to receive an object;
a structure including a plurality of modules configured to receive the pallet with the object, the modules including multi-directional pallet transfer systems, the pallet transfer systems configured to transfer the pallet with the object to adjacent modules in a plurality of directions; and
a control system configured to automatically engage and disengage the multi-directional pallet transfer systems of each module as a pallet is moved relative to the module.

19. The system of claim 18, wherein the control system is configured to receive from a user a request to retrieve from the structure any given module.

20. The system of claim 19, wherein, upon receiving from a user a request to retrieve from the structure a given module, the control system is configured to prioritize the retrieval based upon at least one of a first-come-first-served basis, an amount of fees that is collected from each user, an environmental ranking of the vehicles, a shortest average retrieval time period and energy expenditure.

21. The system of claim 18, wherein the control system includes software that determines an appropriate amount of time to retrieve a vehicle.

22. The system of claim 18, wherein the software is configured to use as a factor in determining an appropriate amount of time to retrieve a vehicle at least one of the size of the parking structure, the number of vehicles that are currently parked in the parking structure, the number of vehicles that are expected to be parked in the parking structure, the time of day, and the type of vehicles.

23. The system of claim 18, wherein the control system communicates via a user interface to receive a request for retrieving a vehicle.

24. A method for moving an object in a structure, comprising:
positioning the object on a pallet;
transferring the pallet and the object from a lift to a first module that is orthogonally located relative to the lift via a multi-directional pallet transfer system of the first module and the lift; and
transferring the pallet and the object from the first module to a second module that is orthogonally located relative to the first module via the multi-directional pallet transfer system of the first module and a multi-directional pallet transfer system of the second module.

25. The method of claim 24, further comprising the step of controlling the multi-directional pallet transfer system via a control system.

26. A method for parking a vehicle in a structure and subsequently retrieving the vehicle, comprising:
positioning the vehicle on a pallet;
transferring the pallet and the vehicle from a lift to parking modules and between different parking modules, wherein the lift and parking modules include multi-directional pallet transfer systems, the pallet transfer systems configured to transfer the pallet with the vehicle to different parking modules in any one of a first forward direction, a second rear direction, a third side direction and a fourth side direction;
positioning the pallet and vehicle in a designated parking module; awaiting a command to retrieve the pallet and vehicle;
positioning the lift to retrieve the pallet and vehicle;
transferring the pallet and vehicle to the lift; and
positioning the lift for retrieval of the vehicle.

27. The method of claim 26, wherein the command is generated by a user.

28. The method of claim 27, wherein the user generates the command by sending a request to retrieve the vehicle.

29. The method of claim 26, wherein the command is generated by software that is configured to determine when a user is likely to a request to retrieve the vehicle.

30. The method of claim 29, wherein, upon the software determining when a user is likely to request to retrieve the vehicle, the controller moves at least one pallet so as to enable the vehicle to be retrieved.

31. The method of claim 30, wherein the controller moves the at least one pallet so as to achieve a shorter retrieval time for the vehicle.

32. A unit for storage, comprising:
a first module including a multi-directional pallet transfer system, the pallet transfer system configured to transfer a pallet with an object to adjacent modules in any one of a first forward direction, a second rear direction, a third side direction and a fourth side direction;
wherein the first module is configured to be adjoined to the adjacent modules.

33. The unit for storage of claim 32, wherein the module is further configured to be securely stacked on top of a lower module.

34. The unit for storage of claim 33, wherein the first module is further configured to have an upper module securely stacked thereon.

35. The unit for storage of claim 32, wherein the object is an automobile.

36. The unit for storage of claim 32, wherein the first module comprises a truss structure.

37. The unit for storage of claim 32, the pallet transfer system includes air casters and a roller system.

38. The unit for storage of claim 37, wherein the roller system includes a roller, an actuator and roller driver.

39. The unit for storage of claim 32, wherein the multidirectional pallet transfer system is configured to be controlled by a computer program.
